(19) United States
(12) Patent Application Publication
(10) Pub. No.: US 2022/0334858 A1
(43) Pub. Date: Oct. 20, 2022

(54) Hybrid Membrane Environment Simulation for Javascript

(71) Applicant: WALLA! COMMUNICATION LTD., Tel Aviv (IL)

(72) Inventor: Avihay Cohen, Tel Aviv (IL)

(21) Appl. No.: 17/636,040

(22) PCT Filed: Sep. 23, 2020
(86) PCT No.: PCT/IB2020/058872

§ 371 Date: Feb. 17, 2022

Related U.S. Application Data
(60) Provisional application No. 62/903,966, filed on Sep. 23, 2019.

(51) Int. Cl. G06F 9/455; H04L 9/40; H04L 67/02

(52) U.S. Cl. CPC G06F 9/45529; H04L 63/1441; H04L 67/02

(57) ABSTRACT

Methods, servers (34) and computer program products implement embodiments of the present invention that include embedding a simulation engine (50) into web code (36) of a web page (24). Upon receiving, from a client computer (20), a request for the web page, the code is conveyed to the computer. Upon receiving the code, the computer initiates execution of the code in a first execution context (90), and initiates execution of the engine. The engine is configured to initiate a second execution context (92) that simulates the first execution context, and to load, to the second execution context, a library (40) for processing content requests. The engine is also configured to proxy, from the first execution context to the second execution context, a call (48) to the library from the code, and to proxy, from the second execution context to the first execution context, a response to the call.

### CROSS-REFERENCE TO RELATED APPLICATIONS

This application claims the benefit of U.S. Provisional Patent Application 62/903,966, filed Sep. 23, 2019, which is incorporated herein by reference.

### FIELD OF THE INVENTION

Embodiments of the present invention relate generally to protecting web code downloaded from a web server, and particularly to preventing any changes to the web code that inhibits browsers from downloading and presenting web content.

### BACKGROUND OF THE INVENTION

Web-based attacks can exploit browsers and their extensions to harvest information such as credentials and payment details, or to infect systems with malware and/or ransomware. In some instances, can be launched by a malicious browser plugin. While some plugins are designed to be malicious, legitimate plug-ins can contain security flaws that can be targeted by an attacker. Successful exploitation of these flaws can enable attackers to perform malicious operations that may include installing ransomware, exfiltrating sensitive data (e.g., intellectual property) or other actions that can put businesses at risk.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method, including embedding, by a processor, a simulation engine into web code of a web page, receiving, from a client computer, a request for the web page, conveying the web code to the client computer in response to the request, wherein receiving the web code by the client computer causes the client computer to initiate execution of the web code in a first execution context, and to initiate execution of the simulation engine, which is configured to initiate a second execution context that simulates the first execution context, to load, to the second execution context that simulates the first execution context, a library for processing content requests, to proxy, from the first execution context to the second execution context, a call to the library from the web code, and to proxy, from the second execution context to the first execution context, a response to the call.

In one embodiment, the response to the call includes a content item, and the method also includes presenting the content item on a display.

In another embodiment, the library includes an advertising library, and the content item includes an advertisement.

In an additional embodiment, the simulation engine is configured to initiate the second execution context by creating an iframe in the first execution context, wherein loading the content library includes loading the library to the iframe.

In a further embodiment, the simulation engine is configured to proxy the call from the first context to the second context by implementing a membrane that enables the call to access the second context.

In a supplemental embodiment, the simulation engine is configured to proxy the response from the second context to the first context by implementing a membrane that enables the response to access the first context.

In some embodiments, the first execution context includes a first document object model (DOM) having a set of first nodes, and the simulation engine is configured to simulate the first execution context by defining a second DOM in the second context, and mirroring the set of the first nodes to a corresponding set of second nodes in the second DOM.

In one embodiment, the method also includes receiving, by the second execution context, the response to the call, defining a new second node in the second DOM, and storing the response to the new second.

In another embodiment, the simulation engine is further configured to proxy the response by creating, in the first DOM, a new first node corresponding to the new second node, and mirroring the new second node to the new first node.

In an additional embodiment, the method also includes randomizing attributes of the new second node.

There is also provided, in accordance with an embodiment of the present invention, a computer software product for protecting a computing system, the product including a non-transitory computer-readable medium, in which program instructions are stored, which instructions, when read by a computer, cause the computer to receive web code including an embedded simulation engine, to initiate execution of the web code in a first execution context, and to initiate execution of the simulation engine, which is configured to initiate a second execution context that simulates the first execution context, to load, to the second execution context that simulates the first execution context, a library for processing content requests, to proxy, from the first execution context to the second execution context, a call to the library from the web code, and to proxy, from the second execution context to the first execution context, a response to

There is additionally provided, in accordance with an embodiment of the present invention, a server, including a memory configured to store web code of a web page, and a processor configured to embed a simulation engine into the web code, to receive, from a client computer, a request for the web page, to convey the web code to the client computer in response to the request, wherein receiving the web code by the client computer causes the client computer to initiate execution of the web code in a first execution context, and to initiate execution of the simulation engine, which is configured: to initiate a second execution context that simulates the first execution context, to load, to the second execution context that simulates the first execution context, a library for processing content requests, to proxy, from the first execution context to the second execution context, a call to the library from the web code, and to proxy, from the second execution context to the first execution context, a response to the call.

There is further provided, in accordance with an embodiment of the present invention, a method, including receiving, by a processor, web code including an embedded simulation engine, initiating execution of the web code in a first execution context, and initiating execution of the simulation engine, which is configured to initiate a second execution context that simulates the first execution context, to load, to the second execution context that simulates the first execution context, a library for processing content requests, to proxy, from the first execution context to the second execution context, a call to the library from the web code, and to proxy, from the second execution context to the first execution context, a response to the call.

### BRIEF DESCRIPTION OF THE DRAWINGS

The disclosure is herein described, by way of example only, with reference to the accompanying drawings, wherein:

FIG. 1 is a block diagram that schematically illustrates a client computer executing a browser that can download web code comprising an embedded simulation engine that inhibits changing functionality of the web code, in accordance with an embodiment of the present invention;

FIG. 2 is a flow diagram that schematically illustrates a method of using the simulation engine to securely request, receive and present website content, in accordance with an embodiment of the present invention;

FIG. 3 is a block diagram that schematically illustrates software and data modules used to securely request, receive and present the web site content, in accordance with an embodiment of the present invention;

FIG. 4 is a block diagram that schematically illustrates an example of a call comprising a request to retrieve content from a content server, in accordance with an embodiment of the present invention;

FIG. 5 is a block diagram that schematically illustrates an example of a response to the call, in accordance with a first embodiment of the present invention; and

FIG. 6 is a block diagram that schematically illustrates an example of a response to the call, in accordance with a second embodiment of the present invention.

### DETAILED DESCRIPTION OF EMBODIMENTS

Embodiments of the present invention provide methods and systems for preventing any change web code functionality, thereby enabling a browser executing the web code to securely request, receive and present content on a web page. As described hereinbelow, a simulation engine is embedded into web code of a web page hosted by a web server. In response to receiving, from a client computer, a request for the web page, the web code is conveyed to the client computer.

Upon the client computer receiving and the web code, a web browser on the client computer initiates execution of the web code in a first execution context, and loads, to a second execution context that simulates the first execution context, a library for processing content requests. The browser can then initiate execution of the simulation engine that initiates a second execution context that simulates the first execution context, and loads, to the second execution context that simulates the first execution context, a library for processing content requests. The simulation engine is also configured to proxy, from the first execution context to the second execution context, a call to the library from the web code, and to proxy, from the second execution context to the first execution context, a response to the call.

In one embodiment, embodiments described herein can proxy the call by passing non-primitives from the first context to the second context via an outbound membrane, and proxy the response by passing non-primitives from the second context to the first context via an inbound membrane. In another embodiment, embodiments described herein can proxy the calls and responses by mirroring the “real” document object model (DOM) in the first context to a mirror DOM in the second context, and mirroring any changes to either DOM. Using JavaScript membranes and DOM mirroring is described in detail hereinbelow.

By proxying calls and responses between the first and the second execution contexts, web sites implementing embodiments of the present invention can prevent any unauthorized changes to content presented on their web pages. For example, if the content comprises advertisements, web sites implementing embodiments described herein can enable a browser executing on the client computer to present advertisements, even in the presence of an adblocker executing on the client computer.

### System Description

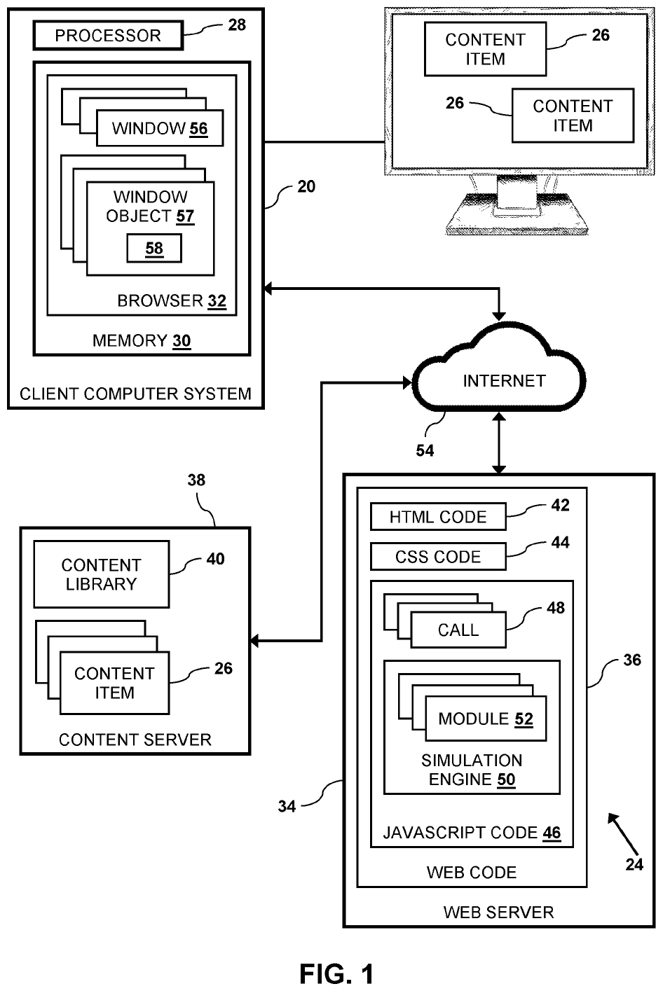

FIG. 1 is a block diagram that schematically illustrates an example of a client computer 20 that is configured to present, on a display 22, a web page 24 comprising one or more content items 26, in accordance with an embodiment of the present invention. Examples of content items include, but are not limited to, images, videos and web advertisements.

Client computer 20 comprises a processor 28 and a memory 30 that stores a web browser 32. To present web page 24, processor 28 executes web browser 32 that transmits, to a web server 34, a request to access web page 24. In response to receiving the request, web server 34 conveys web code 36 to client computer 20, and upon the client computer receiving the conveyed web code, browser 32 renders web page 24 on display 22.

Browser 32 comprises one or more windows 56, and one or more window object 57 corresponding to the one or more windows 56. Each window object 57 comprises multiple read-only window properties 58. Examples of window properties 58 include, but are not limited to, window.location, window.top and window.name

As described supra, web page 24 comprises one or more content items 26. In one embodiment, a content server 38 can host multiple content items 26 and a content library 40 comprising one or more functions that web code 36 can call to download a given content item 26. In this embodiment, web code 36 can instruct browser 32 to download content library 40 to memory 30, and the web code comprises a call to the content library. In embodiments where content items 26 comprise advertisements, content library may comprise an advertisement (ad) library such as the Google Publisher Tag (GPT) Library produced by Alphabet Inc., 1600 Amphitheatre Parkway, Mountain View, Calif. 94043, USA.

Upon receiving the call, content library conveys a request to content server 38, and in response to the request, the content server conveys a given content item 26 to client computer 20. Upon receiving the given content item, web browser can render, to display 22, the given item (i.e., as part of web page 24).

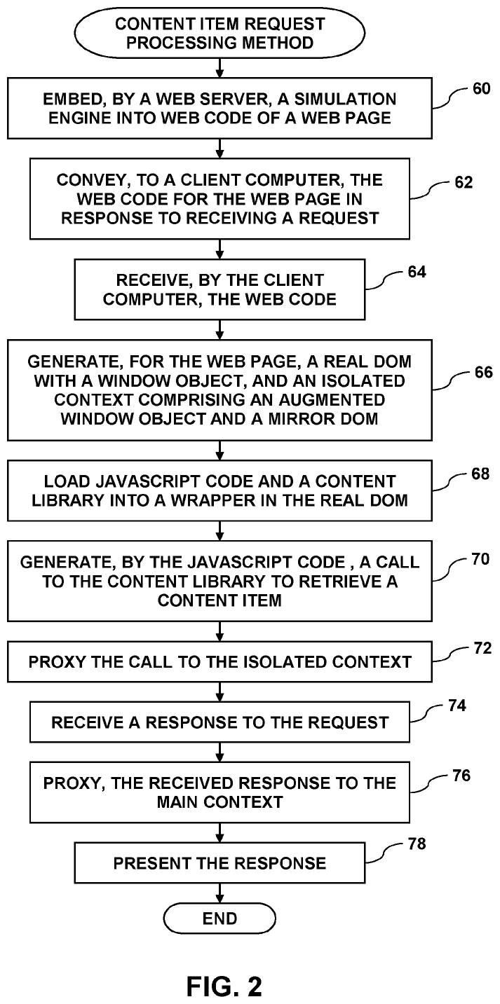

Web code 36 typically comprises Hypertext Markup Language (HTML) code 42, Cascading Style Sheet (CSS) code 44 and JavaScript code 46. In embodiments described herein, JavaScript code 46 comprises one or more calls 48 to content library 40, an embedded simulation engine 50comprising a plurality of software modules 52. Simulation engine 50 is described in the description referencing FIGS. 2-6 hereinbelow, and software modules 52 are described in Appendix 1 hereinbelow.

In the configuration shown in FIG. 1, client computer 20, web server 34 and content server 38 can communicate with each other via a public network 54 such as the Internet. In alternative embodiments, each of the tasks performed by servers 34 and 38 may be split among multiple servers (e.g., in a data cloud).

Processor 28 comprises a general-purpose central processing unit (CPU) or a special-purpose embedded processor, which is programmed in software or firmware to carry out the functions described herein. This software may be downloaded to client computer 20 in electronic form, over a network, for example. Additionally or alternatively, the software may be stored on tangible, non-transitory computer-readable media, such as optical, magnetic, or electronic memory media. Further additionally or alternatively, at least some of the functions of processor 28 may be carried out by hard-wired or programmable digital logic circuits.

Examples of memory 30 include dynamic random-access memories, non-volatile random-access memories, and non-volatile storage devices such as hard disk drives and solid-state disk drives.

### Content Request and Presentation

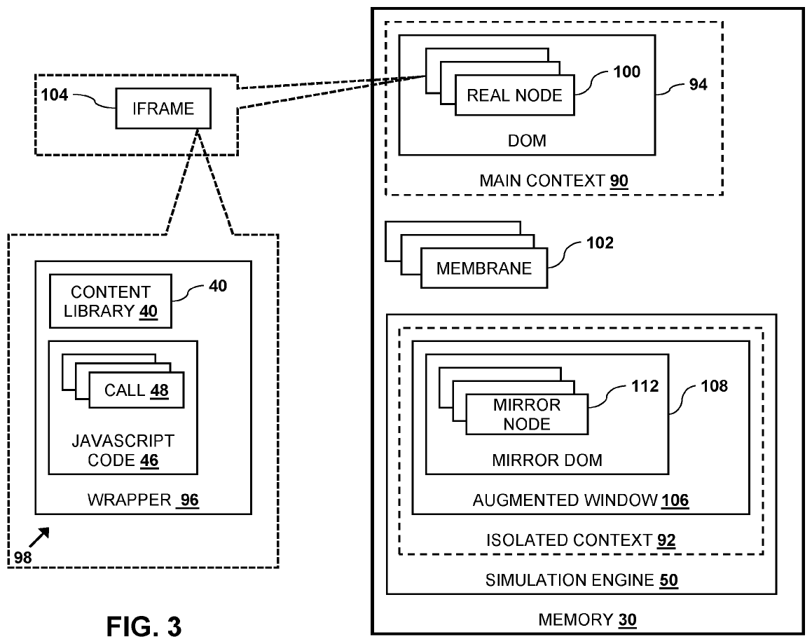

FIG. 2 is a flow diagram that schematically illustrates a method of web browser 32 using simulation engine 50 to process a given call 48 to retrieve a given content item 26 for presentation in web page 24, and FIG. 3 is a block diagram that schematically illustrates a main context 90 (also referred to herein as a first execution context) and an isolated context 92 (also referred to herein as a second execution context) that simulation engine 50 can use to retrieve and present the given content item, in accordance with an embodiment of the present invention.

In step 60, web server 34 embeds simulation engine 50 in JavaScript code 52. To embed simulation engine 50 in web code 36, a programmer (not shown) can add a <script> tag to HTML code 42.

In step 62, web server 34 receives, from client computer 20, a request to access web page 24, and in response to receiving the request, the web server conveys web code 36.

In step 64, client computer 20 receives web code 36. As described supra, web code 36 comprises simulation engine 50.

In step 66, upon receiving web code 36, browser 32 generates main context 90 (i.e., a new execution context) which among generates a document object model (DOM) 94 (FIG. 3) for a given window object 57. DOM 94 comprises a set of real nodes 100 that represent HTML elements for web page 24. In embodiments herein the term “real” nodes 100 indicates that nodes 100 are attached to an execution context, which in this case is main context 90 (i.e., the context created by browser 32).

In embodiments of the present invention, upon receiving web code 36, processor 28 also executes simulation engine 50 that initializes and manages isolated context 92 that mirrors main context 90. To initialize isolated context 92, simulation engine 50 can first create an iframe 104 in main context 90. By creating iframe 104 (which may comprise an empty iframe), simulation engine 50 is able to gain access to the nested execution context of the iframe created by the browser 90. The execution context can be defined as the environment in which browser 32 executes JavaScript code 46. The environment comprises the value of “this”, variables, objects, properties (i.e., from a given window object 57) and functions that JavaScript code 46 has access to at a given time.

Upon creating iframe 104, simulation engine 50 can then create an augmented window 106 in isolated context 92. Augmented window 106 comprises a mirror DOM 108. Mirror DOM 108 comprises a set of mirror nodes 112 that have a one-to-one correspondence with real nodes 100. In operation, simulation module 50 mirrors each real node 100 to its corresponding mirror node 112, and vice versa Mirroring real nodes 100 to mirror nodes 112 is described in Appendix 1.

In some embodiments, simulation engine 50 defines augmented window 106 as a JavaScript proxy object that reflects, using the execution context from iframe 104, main context 90. As described in Appendix 1 hereinbelow, simulation engine 50 can use the JavaScript “with” function to “push” the augmented window proxy object to the top of the scope chain. This enables isolated context 92 to convey, to JavaScript code executing in the isolated context 92, a given property (i.e. a given window property 58) in response to a “get” trap in the JavaScript code. For example, a “get window.location” call in JavaScript code isolated context 92 will return window.location for main context 90 (i.e., not the “real” window.location in the isolated context).

In step 68, simulation engine 50 loads JavaScript code 46 and content library 40 to isolated context 92. In some embodiments, simulation engine 50 can perform step 68 by wrapping JavaScript code 46 and content library 40 in a wrapper 96, and inserting the wrapper into iframe 104 as a <script> tag 98. An example of wrapper 96 comprises:

(function(){with(AugmentedWindowObj){
//Any Javascript Code
}}).call(AugmentedWindowObj);

Wrapper 96 is described in Appendix 1 hereinbelow.

Step 68 enables embodiments of the present invention to successfully process any calls to content library 50 in the event of a plugin (not shown) for browser 32 that blocks content library 40 in main context 90. For example, if content library comprises an ad library, the plugin may comprise an ad-blocker that blocks execution of the ad library in main context 90. For purposes of visual simplicity, content library 40 is only shown in isolated context 92.

In step 70, JavaScript code 46 generates a given call 48 to content library 40 to retrieve a given content item 26 (or any content item 26) from content server 38. For example, if content library 40 comprises Google's GPT library, the given call may comprise

googletag.defineslot (parameter1, . . . parameter).

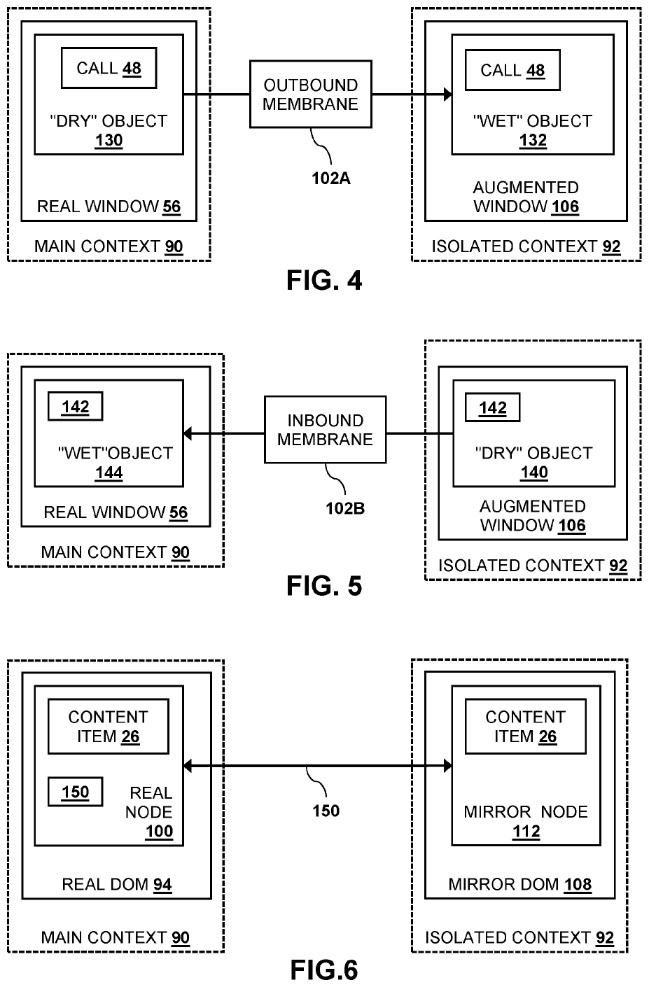

In step 72, simulation engine 50 proxies the given call to the isolated context. In some embodiments, simulation engine 50 can use multiple membranes 102 to proxy and process the given call as described hereinbelow. In FIGS. 4 and 5 (described hereinbelow), membranes 102 can be differentiated by appending a letter to the identifying numeral, so that the membranes comprise outbound membrane 102A and inbound membrane 102B. An explanation of JavaScript membranes can be found at tvcutsem.github.io.

FIG. 4 is a block diagram that schematically illustrates outbound membrane 102A that simulation engine 50 can use in order to proxy the given call to the corresponding mirror node, in accordance with an embodiment of the present invention. In the configuration shown in FIG. 4, a given (real) window 56 comprises a dry object 130 that generates the given call. Outbound membrane 102B passes JavaScript non-primitives from dry object 130 in context 90 to a wet object 132 in context 92.

For example, if content library 40 comprises Google's GPT library, the given call may comprise a googletag object. Since content library 40 only exists in isolated context 92, outbound membrane 102A enables the given call in wet object 132 to successfully access content library 40. In other words, outbound membrane 102A enables the given call to be performed in isolated context 92. In embodiments of the present invention, membranes 102 enable non-primitives to “travel” between isolated context 92 and main context 90 (also known as the “top” context) while simulation engine maintains complete control.

In step 74 simulation engine 50 receives response to the given call, and in step 76, the simulation engine proxies the request to main context 90. As describe hereinbelow, the response may comprise an object (e.g., a plugin for a video player in the main context) or a new node 112.

FIG. 5 is a block diagram that schematically illustrates an example of a response to the given call, in accordance with a first response embodiment of the present invention. In the first response embodiment, the response comprises a dry object 140 comprising JavaScript non-primitives 142. Inbound membrane 102B passes non-primitives 142 from dry object 130 in context 92 to a wet object 144 in context 90, thereby enabling non-primitives successfully access context 90.

FIG. 6 is a block diagram that schematically illustrates an example of a response to the given call, in accordance with a second response embodiment of the present invention. In the second response embodiment, the response comprises a new mirror node 112 comprising a given content item (e.g., HTML code for an advertisement). In the second response embodiment simulation engine 50 proxies the received response by mirroring a new mirrored node 112 to a new corresponding real node 100 (i.e., corresponding to the new mirror node 112).

In the configuration shown in FIG. 6, any mirroring operations (performed by simulation engine 50) between nodes 112 and 100 is indicated by a bidirectional arrow 150. In other words, simulation engine 50 can mirror any changes (i.e., additions, modification deletions) to nodes 100 in DOM 94 to nodes 112 in DOM 108, and mirror any changes to nodes 112 in DOM 108 to nodes 100 in DOM 94. Mirroring operations between nodes 100 and nodes 112 is described in Appendix 1 hereinbelow.

In some embodiments (as described in Appendix 1 hereinbelow), simulation engine 50 can randomize attributes 150 of real node 100B. In instances where browser 32 is executing an adblocker plugin (not shown) and content items 26 comprise advertisements, the randomized attributes can prevent the adblocker from detecting the advertisements.

Finally, in step 80, browser 32 presents the given content item (i.e., in real node 100B) on display 22, and the method ends.

While embodiments described hereinabove use simulation engine 50 to manage presentation of content items 26, other uses of the simulation engine to sandbox web code 36 are considered to be within the spirit and scope of the present invention.

In one example, web page 24 may incorporate third-party code. In this example, simulation engine 50 can enable the third-party code to execute in isolated context 92, thereby preventing the third-party code from accessing private information (e.g., cookies) on client computer 20.

In another example, the third-party code may comprise a payment platform. In this example, if there is a cyber-attack on web code 36, executing the payment platform in isolated content 92 can prevent the attack from exfiltrating any sensitive payment information from web page 24.

### Appendix 1: Software Modules

Embodiments describe herein use simulation engine 50 comprising modules 52. Simulation engine 50 can be coded entirely in native JavaScript which allows it to run in almost any browser on almost any device. The engine can execute any HTML and JavaScript code in a simulated scope without impacting the code functionality and “mirror” any actions made to the main execution context 90 with complete control on every action. Therefore, if ad code (e.g., in code 46) issues an HTTP request to an ad server (e.g., content server 38), the simulation engine can proxy that request while preserving complete functionality (e.g., cookies, headers etc.). In operation, the engine is typically completely invisible to the ad code.

With the “Mirror” and “Reverse Mirror” modules 52 described hereinbelow, embodiments of the present invention can preserve complete functionality for any node 100 in DOM 94 while maintaining the ability to manipulate any “mirrored” node properties (like changing its id attribute from “ad-container” to “Random Value”) even for the web code executing in main context 90.

One given module 52 comprises Init module 52. This module initialize initializes contexts 90 and 92 for further processing, by performing operations such as creating a nested execution context, a detached, a document object, a simulated scope object, and some additional prerequisites.

Another given module 52 comprises abstract syntax tree (AST) module 52. This module transforms JavaScript code 46 into an Abstract Syntax Tree (AST) for further processing. AST module 52 will typically only be used on client computer 20 for cases like eval, new Function, SetTimeout, etc., which evaluates JavaScript from a string. Since other JavaScript processing can take place on the server side (i.e., web server 34), it can be cached for further requests.

For example, AST module can process the JavaScript code

var variable=“test”;

console.log(variable);

to generate the following AST:

{″type″:″Program″,″start″:0,″end″:46,″body″:[{″type″:″VariableDeclaration″,″start″
:0,″end″:22,″declarations″:[{″type″:″VariableDeclarator″,″start″:4,″end″:21,″id″:{″t
ype″:″Identifier″,″start″:4,″end″:12,″name″:″variable″},″init″:{″type″:″Literal″,″start
″:15,″end″:21,″value″:″test″,″raw″:″\″test\″″}}],″kind″:″var″},{″type″:″ExpressionSta
tement″,″start″:23,″end″:45,″expression″:{″type″:″CallExpression″,″start″:23,″end″:
44,″callee″:{″type″:″MemberExpression″,″start″:23,″end″:34,″object″:{″type″:″Ident
ifier″,″start″:23,″end″:30,″name″:″console″},″property″:{″type″:″Identifier″,″start″:3
1,″end″:34,″name″:″log″},″computed″:false},″arguments″:[{″type″:″Identifier″,″start
″:35,″end″:43,″name″:″variable″}]}}],″sourceType″:″module″}

A further given module 52 comprises wrapper module 52. The wrapper module can be used to wrap every JavaScript code so as to can absorb any scope manipulations. In embodiments of the present invention, the wrapper module can also be used to handle the complete mirroring of all properties from the window object in main context 90 (i.e., the real global execution context) to isolated context 92 (i.e., the simulated execution context), and will also inject a Wrapper snippet into every JavaScript code before execution.

For example the code below is a POC snippet that cab used to Mirror “appendChild” method via Getters & Setters and return the necessary method to handle the original call:

Object.defineProperty(Node.prototype,″appendChild″,{get(){
return OurLogicModule(ScopeArguments);
}});

One reason to use Getters & Setters (i.e., instead of directly patching the method) is to detect the method of the call origin (direct/indirect), and to examine all arguments so the appropriate method can be returned to handle the original call properly in order to maintain scope. Keep in mind that this is just a simple snippet to explain the underline logic the real module will handle the Mirroring process much more efficiently.

The engine described herein is completely unique can simulate scope perfectly. The AST (abstract syntax tree) module can generate an AST tree for every JavaScript code and can manipulate every declaration/assignment/expression statement to use our wrapper object. Using the engine, the wrapper module can transform:

window.var1 = ″var1″;
var test1 = ″test1″;
console.log(test1);
GlobalVarAccess = ″AddMeGlovaly″;
var SomeFunc = function(){
var LocalVar = ″Test-Local-Var″;
console.log(LocalVar);
};

into the following:

(function(window,wrapped){
window.var1 = ′var1′;
wrapped.test1 = ′test1′;
console.log(wrapped.test1);
window.GlobalVarAccess = ″AddMeGlovaly″;
window.SomeFunc = function(){
try{throw wrapped.createNestedContext(″SomeFunc″)}catch(wrapped) {
wrapped.LocalVar = ″Test-Local-Var″;
console.log(wrapped.LocalVar);
}
};
})(wrapper.mainObj,wrapper);

In this example, the entire code can be wrapped in an Immediately Invoked Function Expression (IIFE) with two arguments (window & wrapped), wherein the window argument holds “wrapper.mainObj” which is the main object and the “wrapped” argument which holds a specially nested scoped object. In this case the specially nested scoped object is the same as “wrapper.mainObj” because it is still on the main scope.

Additionally, every global declaration/assignment (even if performed indirectly like “GlobalVarAccess=‘AddMe . . . ”) will be changed to hold the ‘window.’ prefix so that the wrapper.mainObj can be used. Since it was introduced to the current scope as ‘window’ it will “shadow” the global window object.

Furthermore, every local scope declaration/assignment/access . . . can be added the “wrapped.” Prefix. For example, ‘LocalVar’ inside SomeFunc can be transformed into ‘wrapped.LocalVar’.

In some embodiments, every function can be transformed and wrapped with

‘try{throw wrapped.createNestedContext(“SomeFunc)}catch(wrapped){}’

The reason ‘try&catch’ is used is because the catch clause introduces the error object from the throw statement in the try clause to the catch clause scope. Therefore, the createNestedContexe method creates a new wrapper object with the prototype of the parent. This way, the prototype lookup functionality in JavaScript can be exploited to simulate scope lookup. So in reality, every local variable can reside inside the nested wrapper object.

For example, in the code:

var SomeFunc = function(){
var LocalVar = ″Test-Local-Var″;
var NestedFunc = function(){
var NestedFunc2 = function(){
console.log(LocalVar);
};
NestedFunc2();
};
NestedFunc();
};
SomeFunc();

the call to “console.log(LocalVar)” searches for the LocalVar' variable in the current function scope, but since it does not exist, the code will try to find it in the ‘NestedFunc’ scope. Since it also does not exist there as well, the code it will then search the SomeFunc' scope, where it can be found. The code can then print “Test-Local-Tar” to the console.

Transforming this code with the wrapper module results in the following code:

function(window,wrapped){
window.SomeFunc = function(){
try{throw wrapped.createNestedContext(″nestedFunc15147″)}catch(wrapped) {
wrapped.LocalVar = ″Test-Local-Var″;
wrapped.NestedFunc = function(){
try{throw wrapped.createNestedContext(″nestedFunc15147″)}catch(wrapped) {
wrapped.NestedFunc2 = function(){
try{throw wrapped.createNestedContext(″nestedFunc15147″)}catch(wrapped) {
console.log(wrapped.LocalVar);
}
};
wrapped.NestedFunc2();
}
};
wrapped.NestedFunc();
}
};
window.SomeFunc();
})(wrapper.mainObj,wrapper);

In this code, every function uses the parent ‘wrapped’ object to create its own ‘wrapped’ object from the prototype of its parent. In this case, the call to “console.log(wrapped.LocalVar)” will first search “LocalVar” on the current wrapper object. Since it will not find it, it will search for it in its prototype chain all the way up to the main ‘wrapped’ object. This enables perfect simulation of the scope chain lookup without introducing a single variable to the global scope or the function scope (local scope), except to the ‘wrapped’ object that holds everything. The wrapped object can function\ in a similar manner to an activation object.

Going back to the previous example:

function inIframe () {
try {
return window.self !== window.top;
} catch (e) {
return true;
}
}

In this example, the web server can wrap/embed any JavaScript code in the following manner:

function(window,wrapped){
function inIframe () {
try{throw wrapped.createNestedContext(″nestedFunc15147″)}catch(wrapped) {
try {
return window.self !== window.top;
} catch (e) {
return true;
}
}
}
})(wrapper.mainObj,wrapper);

In this example, since everything is inside the IIFE, the ‘window.top’ property is actually the ‘wrapped.top’ property.

In another example:

var Func1_localVar = ″func1_local″;
var Func2 = function(){
eval(″var innerVar = \″innerValue\″; console.log(Func1_localVar);″);
console.log(innerVar);
}
Func2();
}
Func1();

In this example, the JavaScript code can be wrapped as follows:

function(window,wrapped){
window.Func1 = function(){
try{throw wrapped.createNestedContext(″nestedFunc15147″)}catch(wrapped) {
wrapped.Func1_localVar = ″func1_local″;
wrapped.Func2 = function(){
try{throw wrapped.createNestedContext(″nestedFunc15147″)}catch(wrapped) {
eval(″wrapped.innerVar = \″innerValue\″; console.log(wrappedFunc1_localVar);″);
console.log(wrapped.innerVar);
}
}
wrapped.Func2();
}
}
window.Func1();
})(wrapper.mainObj,wrapper);

These two code snippets hold the same logic, with the difference being that by using the wrapper and the AST module, the activation object can be simulated for each function. This enables controlling simulated scope, which is typically impossible in any JavaScript engine. For example, if the adblocker injects some JavaScript to patch the eval method and replace it with something else, this enables skipping the eval method, and just injecting the JavaScript code with the wrapper as a regular script tag, thereby preserving the same functionality as eval. In this example, the eval method is called directly from inside the Func2 scope which will introduce the “innerVar” variable to that function scope. This enables the next call to console.log' to successfully print ‘inner Value’ in both snippets. Since the simulated scope is controlled, it can also preserve the exact same logic even if we remove the eval call and just inject the JavaScript string as a script tag.

In the cases of dynamic code evaluation like ‘eval’, the JavaScript code can be parsed with the AST module. If the current browser 32 and the JavaScript code meets specific constraints , the code manipulation can be skipped, a special wrapper that uses the JavaScript ‘with’ statement in conjunction with the ‘Proxy’ API can be used to achieve (in some ways) the same scope manipulation in previous techniques.

The following code can be used for implementation:

var metaP_WrapperLogic = function(jsCode) {
var proxy = new Proxy({}, {
get(target, key) {
return wrapper[key];
},
has(target, key) {
return true;
}
});
return (″(function(){with(window.proxy){ ″ + jsCode + ″};})();″);

For example, the code snippet (listed hereinabove):

window.var1 = ″var1″;
var test1 = ″test1″;
console.log(test1);
GlobalVarAccess = ″AddMeGlobally″;
var SomeFunc = function(){
var LocalVar = ″Test-Local-Var″;
console.log(LocalVar);
};

will be transformed to:

(function(){
with(wrapped) {
window.var1 = ″var1″;
var test1 = ″test1″;
console.log(test1);
GlobalVarAccess = ″AddMeGlobally″;
var SomeFunc = function () {
with(wrapped.createNestedContext(″SomeFunc″)) {
var LocalVar = ″Test-Local-Var″;
console.log(LocalVar);
}
};
}
})();

When using wrapper module 52, the ‘with’ statement in JavaScript actually introduces the ‘wrapped’ object to the top of the scope chain. Additionally, the JavaScript Proxy API enables trapping of the binding object ‘hasOwnProperty’. Therefore, when JavaScript traverses the scope chain to resolve variable reference, it calls ‘hasOwnProperty’ on the objects that are currently in the scope chain starting from the top. By using the ‘with’ statement to push the proxied object to the top of the chain, a trap in the proxy object will always return ‘True’ for any property lookup enables complete control over every variable in the current body. In some embodiments, the ‘with’ statement block can be introduced to every function body in order to maintain the ability to simulate control over the activation object for each scope.

An additional given module 52 comprises mirror module 52. The mirror module can be called by engine 50 for every scope or DOM manipulation. Upon processing/manipulating each call the mirror module “mirrors” the calls it to the real main scope/DOM. For example:

var div=document. createElement(“div”);

div.setAttribute(“id”,“testdiv”);

document.body.appendChild(div);

This snippet creates a div element with id=“testdiv”, and appends it to the body section of the page. When this code is executed by the engine the div element will be created on a detached document, and while this mirror module will mirror it to the DOM 94, it will also allow any desired manipulations.

For example, consider a scenario where the engine is running on a given website, and the user uses an adblocker extension to block ads, which results in blocking any element that contains ads identifiers (e.g., any element with id/class that contains the keywords “ads”, “interstitial”, “ad-container”, etc.). If the ad code tries to create a div such as

var div=document. createElement(“div”);

div.setAttribute(“id”,“ad-div-123”);

document.body.appendChild(div);

the div will be blocked by the adblock extension.

However, if this code is executed by the engine, the div with the id=“addiv-123” will still be created, but on the detached hidden document object. Before the Mirror module mirrors the div to the main DOM (i.e., DOM 94) every attribute can be randomized. In this instance, the engine will append a div with an id=“SomeRandValue” to the main DOM which will result in complete bypass of the adblocker extension.

Additionally, the mirror module can also manage any correlation between the original div and the new randomized one. Therefore, after creating the div, if the ad code tries to access the new element by calling:

document.getElementById(“ad-div-123”)

the call will return the original div from the detached document. However, any manipulations to this div will be reflected both on the detached div without any changes and on the div in the main DOM (i.e., with any necessary changes).

For example, if there is a call to

“div.setAttribute(”id“,”ad-container“);”

the call will be reflected unchanged to the detached div. However, for the div in the main DOM this call can be manipulated with a random id.

The logic described herein allows any code that runs in the engine scope to maintain complete functionality, while enabling the performance of any manipulation for DOM minoring (e.g., like the example hereinabove and for any prop mirroring).

A further given module 52 comprises reverse mirror module 52. The reverse minor module exists between the main scope (i.e., main context 90) and the simulated scope (i.e., isolated context 92). As the engine creates a separated simulated scope, the (regular) Mirror module 52 can only handle manipulations from within this scope. Consider the following scenario:

Code that runs in the simulated scope creates and appends a div, and create a global property such as:

var div=document. createElement(“div”);

div.setAttribute(“id”,“div-container”);

document.body.appendChild(div);

window.importantFunction=function( ){console.log(“I'm Very Important”)}

Other code that executes in the main scope (which the engine does not control) and tries to call “importantFunction” or access the div with id “divcontainer”.

The reverse mirror module enables successful execution of this scenario, since the div injected to the main DOM has a randomized id and the “importantFunction” only exists on the nested scope.

One more given module 52 comprises CSS Object Model (CSSOM) 52. The CSSOM module can be configured to handle all stylesheets for the current execution context. Since simulation engine 50 can strip all attributes from the “real” attached nodes (i.e., nodes 102), the original stylesheets (not shown) will not affect the relevant nodes. Therefore, the CSSOM module can match all CSS rules to the relevant mirror nodes 112 (which hold all the original attributes), and reflect the matched rules to the relevant execution context with a new selector that matches the relevant real nodes.

In some embodiments, the reverse minor module can be called on every DOM manipulation event with markers injected by the wrapper module. This enables the reverse minor module to scan the nested scope for global scope properties, and to (a) mirror them to the main scope, and (b) create a twin element for any element that the Minor module appended to the DOM 94 (but with the original attributes, and completely hidden). Therefore, if any code on the main scope tries to manipulate/call any element/method, the reverse mirror module can mirror it to the scope.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
embedding, by a processor, a simulation engine into web code of a web page;
receiving, from a client computer, a request for the web page;
conveying the web code to the client computer in response to the request, wherein receiving the web code by the client computer causes the client computer:
to initiate execution of the web code in a first execution context; and
to initiate execution of the simulation engine, which is configured:
to initiate a second execution context that simulates the first execution context,
to load, to the second execution context that simulates the first execution context, a library for processing content requests,
to proxy, from the first execution context to the second execution context, a call to the library from the web code, and
to proxy, from the second execution context to the first execution context, a response to the call.

2. The method according to claim 1, wherein the response to the call comprises a content item, and comprising presenting the content item on a display.

3. The method according to claim 2, wherein the library comprises an advertising library, and wherein the content item comprises an advertisement.

4. The method according to claim 1, wherein the simulation engine is configured to initiate the second execution context by creating an iframe in the first execution context, wherein loading the content library comprises loading the library to the iframe.

5. The method according to claim 1, wherein the simulation engine is configured to proxy the call from the first context to the second context by implementing a membrane that enables the call to access the second context.

6. The method according to claim 1, wherein the simulation engine is configured to proxy the response from the second context to the first context by implementing a membrane that enables the response to access the first context.

7. The method according to claim 1, wherein the first execution context comprises a first document object model (DOM) having a set of first nodes, and wherein the simulation engine is configured to simulate the first execution context by defining a second DOM in the second context, and mirroring the set of the first nodes to a corresponding set of second nodes in the second DOM.

8. The method according to claim 7, and comprising receiving, by the second execution context, the response to the call, defining a new second node in the second DOM, and storing the response to the new second node.

9. The method according to claim 8, wherein the simulation engine is configured to proxy the response by creating, in the first DOM, a new first node corresponding to the new second node, and mirroring the new second node to the new first node.

10. The method according to claim 8, and comprising randomizing attributes of the new second node.

11. A computer software product for protecting a computing system, the product comprising a non-transitory computer-readable medium, in which program instructions are stored, which instructions, when read by a computer, cause the computer:
to receive web code comprising an embedded simulation engine;
to initiate execution of the web code in a first execution context; and
to initiate execution of the simulation engine, which is configured:
to initiate a second execution context that simulates the first execution context,
to load, to the second execution context that simulates the first execution context, a library for processing content requests,
to proxy, from the first execution context to the second execution context, a call to the library from the web code, and
to proxy, from the second execution context to the first execution context, a response to the call.

12. The computer software product according to claim 11, wherein the response to the call comprises a content item, and wherein the instructions further cause the computer to present the content item on a display.

13. The computer software product according to claim 12, wherein the library comprises an advertising library, and wherein the content item comprises an advertisement.

14. The computer software product according to claim 11, wherein the simulation engine is configured to initiate the second execution context by creating an iframe in the first execution context, wherein loading the content library comprises loading the library to the iframe.

15. The computer software product according to claim 11, wherein the simulation engine is configured to proxy the call from the first context to the second context by implementing a membrane that enables the call to access the second context.

16. The computer software product according to claim 11, wherein the simulation engine is configured to proxy the response from the second context to the first context by implementing a membrane that enables the response to access the first context.

17. The computer software product according to claim 11, wherein the first execution context comprises a first document object model (DOM) having a set of first nodes, and wherein the simulation engine is configured to simulate the first execution context by defining a second DOM in the second context, and mirroring the set of the first nodes to a corresponding set of second nodes in the second DOM.

18. The computer software product according to claim 17, wherein the instructions are further configured to receive, by the second execution context, the response to the call, to define a new second node in the second DOM, and to store the response to the new second node.

19. The computer software product according to claim 18, wherein the simulation engine is configured to proxy the response by creating, in the first DOM, a new first node corresponding to the new second node, and mirroring the new second node to the new first node.

20. The computer software product according to claim 18, wherein the instructions are further configured to randomize attributes of the new second node.

21. A server, comprising:
a memory configured to store web code of a web page; and
a processor configured:
to embed a simulation engine into the web code;
to receive, from a client computer, a request for the web page;
to convey the web code to the client computer in response to the request, wherein receiving the web code by the client computer causes the client computer:
to initiate execution of the web code in a first execution context; and
to initiate execution of the simulation engine, which is configured:
to initiate a second execution context that simulates the first execution context,
to load, to the second execution context that simulates the first execution context, a library for processing content requests,
to proxy, from the first execution context to the second execution context, a call to the library from the web code, and
to proxy, from the second execution context to the first execution context, a response to the call.

22. A method, comprising:
receiving, by a processor, web code comprising an embedded simulation engine;
initiating execution of the web code in a first execution context; and
initiating execution of the simulation engine, which is configured:
to initiate a second execution context that simulates the first execution context,
to load, to the second execution context that simulates the first execution context, a library for processing content requests,
to proxy, from the first execution context to the second execution context, a call to the library from the web code, and
to proxy, from the second execution context to the first execution context, a response to the call.
